(19) United States
(12) Patent Application Publication
(10) Pub. No.: US 2025/0032347 A1
(43) Pub. Date: Jan. 30, 2025

(54) MASSAGE DEVICE HAVING ROTATABLE ARM MASSAGE UNIT

(71) Applicant: BODYFRIEND CO., LTD., Seoul (KR)

(72) Inventors: Beom Seok LEE, Seoul (KR); Myeong Jin YOU, Seoul (KR)

(21) Appl. No.: 18/280,620

(22) PCT Filed: Jul. 7, 2023
(86) PCT No.: PCT/KR2023/009618

§ 371 Date: Sep. 6, 2023

(30) Foreign Application Priority Data
Jul. 7, 2022 (KR) 10-2022-0084027
Jul. 6, 2023 (KR) 10-2023-0087681

(51) Int. Cl. A61H 15/00

(52) U.S. Cl. CPC A61H 15/0078; A61H 2201/0149; A61H 2201/149

(57) ABSTRACT

Provided is a massage device capable of providing various functions to a user by including a rotatable arm massage unit. The massage device includes: a body massage unit including a main frame forming the skeleton of the massage device, and massaging a user's body; arm massage units respectively arranged on both sides of the body massage unit, accommodating both arms of the user, and configured on the body massage unit to rotate around a rotational shaft; and a rotation module rotating the arm massage units, wherein the rotation module comprises: an arm rotation actuator which has an end connected to the main frame and includes an expandable rod expanding or contracting in one direction; and a motion conversion member which is connected to the other end of the arm rotation actuator and the arm massage unit, and converts a linear motion of the expandable rod into a rotational motion of the arm massage unit.

### TECHNICAL FIELD

The present invention relates to a massage device having a rotatable arm massage unit, and more particularly, to a massage device capable of providing various functions to a user by including a rotatable arm massage unit which massages arm parts of a user.

### BACKGROUND ART

Massage is a medical assistance therapy for controlling a user's physical modulation, helping blood circulation, and relieving fatigue of the user by applying various types of mechanical stimulation to a portion of the body, such as massaging, pressing, pulling, tapping, or moving a portion of the body of the user.

The growth in a massage demand caused an increase in demand for massage devices or massage devices, which provide an artificial massage function, because of economic feasibility and temporal reasons. That is, as the demand for relieving fatigue or stress is increased while loosening the agglomerated muscles through massage, various mechanical massage devices for time and cost efficiencies are being released.

Recently, there is an increase in interest in health of people, and the massage device is changing as an electronic device providing various additional functions, and/or medical functions from a device simply providing a massage function. Accordingly, researches on how to efficiently control a massage device are continued.

In particular, since users may have different regions to get a massage and may be different in desired stimulation from one another, the demand for apparatuses and methods providing a massage optimized for each user is increasing.

As an example, Japanese Patent Laid-open No. 2015-027424 discloses a massage device having an arm massage unit.

### DISCLOSURE

### Technical Problem

Accordingly, the present invention has been made in view of the above-mentioned problems occurring in the related art, and it is an object of the present invention to provide a massage device capable of providing various functions to a user by including a rotatable arm massage unit which massages arm parts of a user.

It is another object of the present invention to provide a massage device capable of simplifying the configuration for rotational operation of the arm massage unit and minimizing a space where the massage device occupies.

The objects of the present disclosure are not limited to those mentioned above, and other objects not mentioned herein will be clearly understood by those skilled in the art from the following description.

### Technical Solution

To accomplish the above-mentioned objects, according to the present invention, there is provided a massage device including: a body massage unit including a main frame forming the skeleton of the massage device, and massaging a user's body: arm massage units respectively arranged on both sides of the body massage unit, accommodating both arms of the user, and configured on the body massage unit to rotate around a rotational shaft; and a rotation module rotating the arm massage units, wherein the rotation module comprises: an arm rotation actuator which has an end connected to the main frame and includes an expandable rod expanding or contracting in one direction; and a motion conversion member which is connected to the other end of the arm rotation actuator and the arm massage unit, and converts a linear motion of the expandable rod into a rotational motion of the arm massage unit.

### Advantageous Effect

The massage device according to the present invention can provide various functions to a user by including a rotatable arm massage unit.

Moreover, the massage device according to the present invention can provide various massage functions and stretching functions to the user's arms and shoulders by vertically rotating the arm massage unit. For instance, the massage device can perform stretching or other medical treatments by rotating or expanding the user's arm in a specific direction through the rotation of the arm massage unit.

Furthermore, the massage device of the present invention can provide convenience when the user sits on or stands up from the massage device by rotating the arm massage unit vertically.

Specifically, the massage device of the present invention can rotate the arm massage unit by converting the linear motion of the extendable rod of the arm rotation actuator into a rotational motion through a motion conversion member and transferring the rotational motion to the arm massage unit in a state in which the arm rotation actuator is fixed. Therefore, the the massage device of the present invention can rotate the arm massage unit very smoothly and stably compared with the conventional art which rotates the arm massage unit just by the linear motion or the rotational motion of the driving device, can generate little noise and vibration during the rotation, and can overcome the problems of drive force waste and increased power consumption.

In addition, since the expandable rod of the arm rotation actuator maintains a completely fixed state without lateral vibration of the arm rotation actuator when the expandable rod of the arm rotation actuator operates, the massage device of the present invention can reduce an installation space of the arm rotation actuator, prevent noise and vibration by eliminating interference between the arm rotation actuator and other components, and enhance durability by preventing failures.

The effects of the present invention are not limited to the above-mentioned effects, and other effects, which are not specifically mentioned herein, will be clearly understood by those skilled in the art from the following description.

### DESCRIPTION OF DRAWINGS

FIG. 1 is a view illustrating a massage device according to an embodiment of the present invention.

FIG. 2 is a view illustrating a main frame of FIG. 1.

FIG. 3 is a view illustrating a detailed configuration of a massage device according to an embodiment of the present invention.

FIG. 4 is a view illustrating external devices which can communicate with the massage device according to an embodiment of the present invention.

FIGS. 5A and 5B are views illustrating a massage device having a rotatable arm massage unit according to an embodiment of the present invention.

FIG. 6 is a perspective view illustrating a connection structure between the arm massage unit and the main frame of the massage device according to an embodiment of the present invention.

FIG. 7 is a side view illustrating a connection structure between the arm massage unit and the main frame of the massage device of FIGS. 5A and 5B.

FIG. 8 is a perspective view illustrating the arm massage unit of the massage device of FIGS. 5A and 5B.

FIG. 9A is an exploded perspective view illustrating the arm massage unit of the massage device of FIGS. 5A and 5B.

FIG. 9B is an exploded perspective view illustrating some components of a rotation module of the arm massage unit of the massage device of FIGS. 5A and 5B.

FIG. 10 is a view illustrating an operation example of the arm massage unit of the massage device of FIGS. 5A and 5B.

FIG. 11 is a side view illustrating a state in which leg massage units of the massage device according to an embodiment of the present invention rotate individually.

FIG. 12 is a view illustrating a state in which the leg massage unit of the massage device according to an embodiment of the present invention is connected to a leg connection frame.

### BEST MODE

A massage device includes: a body massage unit including a main frame forming the skeleton of the massage device, and massaging a user's body: arm massage units respectively arranged on both sides of the body massage unit, accommodating both arms of the user, and configured on the body massage unit to rotate around a rotational shaft; and a rotation module rotating the arm massage units, wherein the rotation module comprises: an arm rotation actuator which has an end connected to the main frame and includes an expandable rod expanding or contracting in one direction; and a motion conversion member which is connected to the other end of the arm rotation actuator and the arm massage unit, and converts a linear motion of the expandable rod into a rotational motion of the arm massage unit.

### MODE FOR INVENTION

The objects, features, and advantages of the present invention described above will become more apparent through the following embodiments in connection with the accompanying drawings.

The following specific structure to functional descriptions are illustrated for the purpose of describing an embodiment according to the concept of the present invention, and embodiments according to the concept of the present invention may be implemented in various forms and should not be construed as being limited to the embodiments described herein or the application.

The embodiments according to the concepts of the present invention may apply various changes and may have various forms, and thus certain embodiments are illustrated in the drawings and will be described in detail in the specification or application. However, it should be understood that the embodiments of the present invention are not intended to limit the embodiments of the present invention to a specific disclosure, and include all modifications, equivalents, and replacements included in the spirit and technical scope of the present invention.

Terms such as first and/or second may be used to describe various components, but the components are not limited to the terms. The terms are only for the purpose of distinguishing one component from other components, for example, without departing from the scope of the present invention, a first component may be referred to as a second component, and similarly, a second component may also be referred to as a first component.

It should be understood that when a component is referred to as being “connected” or “coupled” to another component, it may be directly connected or coupled to the other component, but it should be understood that there may be other components therebetween. On the other hand, when a component is referred to as being “directly connected” or “directly coupled” to another component, it should be understood that there is no other component therebetween. Other expressions for describing the relations between the components, that is, the expression “between” and “directly between” or “adjacent to” and “directly adjacent to” should be interpreted in the same manner.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

In this specification, an actuator means a component capable of providing a driving force. For instance, the actuator may be a motor, a linear motor, an electronic motor, a DC motor, an AC motor, a linear actuator, an electric actuator, or the like, but is not limited thereto.

In this specification, a binaural beat may refer to audio information of a specific form capable of adjusting brainwaves.

In this specification, according to an embodiment, the massage device may include a body massage unit and a leg massage unit. In addition, according to another embodiment, the body massage unit and the leg massage unit may be provided as separate devices (for example, a body massage device and a leg massage device), and the massage device may refer to a body massage device or a leg massage device.

Hereinafter, embodiments of the present invention will be described in more detail with reference to the accompanying drawings.

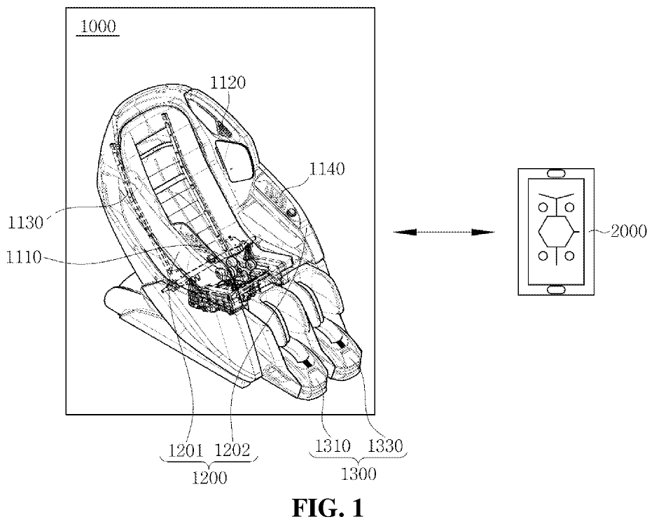

FIG. 1 is a view illustrating a massage device 1000 according to an embodiment of the present invention.

The massage device 1000 according to an embodiment of the present invention has an area for accommodating at least a portion of the body of a user, supports the a body part of the user (for example, the body), and includes a massage unit for massaging a portion of the body of the user.

The massage unit may include at least one of a body massage unit 1100 massaging at least a portion of the body of the user, an arm massage unit 1200 massaging the user's arms, and at least one of leg massage units 1300 massaging the user's legs.

The body massage unit 1100 can massage at least a portion of the body of the user. For example, the body massage unit 1100 can massage at least a portion of at least one of the upper body and the lower body of the user.

Specifically, the body massage unit 1100 may include a massage module 1110 providing a massage function to at least a portion of the body of the user, an audio output module 1120 providing any type of audio output to the user, a main frame 1130 forming the framework of the body massage unit 1100 and supporting the user's body, and a user input unit 1140 receiving any type of input from the user.

The components included in the body massage unit 1100 are just exemplary embodiments, and the body massage unit 1100 may include other various components.

Additionally, the shape and the structure of the massage device 1000 illustrated in FIG. 1 are just examples, and various types of the massage device 1000 can be included within the scope of the present invention without departing from the scope of the present invention defined by the claims of the present invention.

The body massage unit 1100 can form a space of any shape to accommodate the user. The body massage unit 1100 may have a space with the shape corresponding to the shape of the body of the user. For example, as illustrated in FIG. 1, the body massage unit 1100 can be realized as a seat type that can accommodate the user's whole body or a portion of the body and can support at least a portion of the body of the user. For example, the body massage unit 1100 may include a backrest supporting at least a portion of the user's upper body, and a seat supporting at least a portion of the user's lower body.

A portion of the body massage unit 1100 contacting the ground may include any material or component (for example, an anti-slip pad) for increasing frictional force, and may include wheels for enhancing mobility of the massage device 1000.

At least a portion of the body massage unit 1100 can slide. For instance, when the body massage unit 1100 starts a massage (or when the body massage unit 1100 is activated), at least a portion of the body massage unit 1100 can slide forward. Additionally, the body massage unit 1100 can tilt backwards. As a result, the body massage unit 1100 can provide a massage while tilted backwards. For instance, the massage device 1000 may include an actuator that tilts the massage device 1000 or the body massage unit 1100 in the backward direction of the massage device 1000 or the body massage unit 1100. The massage device 1000 can activate the actuator to tilt the body massage unit 1100 or restore the body massage unit 1100 to the original state. In this instance, the actuator can be placed in at least a portion of the massage device (for example, a base frame).

According to an embodiment of the present invention, the massage device 1000 may include at least one air cell (not illustrated). The air cell can be located in at least one area of the body massage unit 1100 (for instance, at least one of an area corresponding to the user's shoulder, an area corresponding to the pelvis, an area corresponding to the waist, out of the entire area of the body massage unit 1100), at least an area of the arm massage unit 1200, and at least an area of the leg massage unit 1300, but is not limited thereto, and may be placed in various parts of the massage device 1000.

The massage device 1000 may include an air supply unit, which can inflate the air cell by supplying air to the air cell. The air supply unit may be located inside the body massage unit 1100 or may be located inside the leg massage unit 1300. Moreover, the air supply unit can be located outside the massage device 1000.

The massage module 1110 may be installed inside the body massage unit 1100 to provide any type of mechanical stimulation to a user accommodated in the body massage unit 1100. As illustrated in FIG. 1, the massage module 1110 can move along the main frame 1130 installed inside the body massage unit 1100. The massage module 1110 can massage at least a portion of the body of the user while moving along the main frame 1130.

The main frame 1130 of the body massage unit 1100 may include a rack gear 1131a, and the massage module 1110 can provide mechanical stimulation to various parts of the body of the user by moving along the rack gear. For example, the massage module 1110 can massage the user's back, shoulders, waist, buttocks, thighs, or at least one of such body parts by tapping or kneading. The massage module 1110 may include at least one massage unit among a ball massage unit and a roller massage unit, but is not limited thereto.

The main frame 1130 can form a frame of the internal configuration of the body massage unit 1100, and may be made of metal or plastic. For example, the main frame 1130 may be made of iron, alloy, steel, etc., but is not limited thereto, and can be made of various hard materials.

The audio output module 1120 may be provided in various locations. For example, the audio output module 1120 may include multiple output units such as a top audio output unit placed on the top of the seat part in contact with the user, a front audio output unit coupled to the front end of the arm massage unit 1200 on both sides of the seat part, and/or a rear audio output unit coupled to the rear end of the arm massage unit 1200, but is not limited thereto. In this case, the audio output module 1120 can provide stereophonic sound such as 5.1 channels, but is not limited thereto.

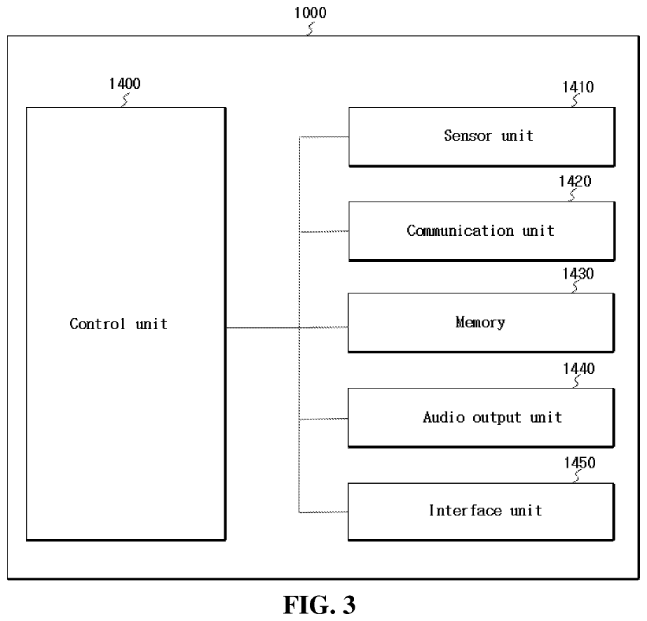

The arm massage unit 1200 may be arranged at least on one side of the body massage unit 1100. For example, the arm massage unit 1200 may include at least one between a first arm massage unit 1210 arranged on one side of the body massage unit 1100 to massage a user's one arm, and a second arm massage unit 1230 arranged on the other side of the body massage unit 1100 to massage the user's other arm. The first arm massage unit 1210 may be arranged on at least one side of the seat part and the backrest part of the body massage unit 1100. The second arm massage unit 1230 may be arranged on the other side of at least one of the seat part and the backrest part of the body massage unit 1100. The first and second arm massage units 1210 and 1230 can operate independently based on the control of a control unit 1400 (refer to FIG. 3) which controls the massage device 1000.

The leg massage unit 1300 may be arranged at the bottom of the body massage unit 1100 and/or at the front bottom of the massage device 1000. The leg massage unit 1300 may include at least one of a first leg massage unit 1310 placed on one side of the leg massage unit 1300 to massage the user's one leg, and a second leg massage unit 1330 placed on the other side of the leg massage unit 1300 to massage the user's other leg.

The leg massage unit 1300 includes a receiving space for accommodating the user's leg, and can provide a leg massage to the user by massaging at least a portion of the user's leg. For example, the leg massage unit 1300 may include a calf massage unit which massages the user's calf and/or a foot massage unit which massages the user's foot.

The leg massage unit 1300 is adjustable in length according to the user's body characteristics. For example, when a user who is tall uses the massage device 1000, it is necessary to extend the length of the leg massage unit 1300 since the user's calves are long. Moreover, when a user who is short uses the massage device 1000, it is necessary to reduce the length of the leg massage unit 1300 since the user's calves are short. Accordingly, the leg massage unit 1300 can provide a leg massage tailored to the user's height. According to an embodiment of the present invention, the user can control the massage device 1000 using a massage device control device 2000. The massage device control device 2000 can be connected to the massage device 1000 through wired communication and/or wireless communication.

The massage device control device 2000 may include at least one user device (personal device), such as a remote controller, a cellular phone, and a PDA (Personal Digital Assistant), but is not limited thereto, and may include various electronic devices that can be connected to the massage device 1000 through wired or wireless communication.

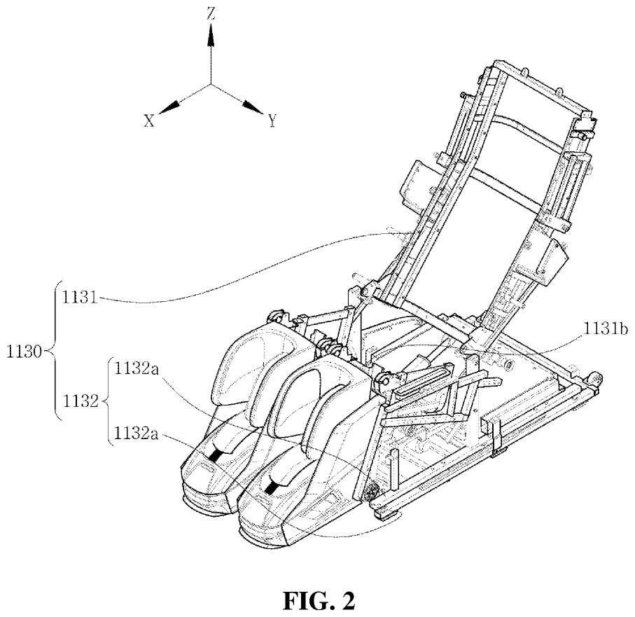

FIG. 2 is a view illustrating a massage device according to an embodiment of the present invention.

According to an embodiment of the present invention, the main frame 1130 may include an upper frame 1131, on which a massage module 1110 is provided, and a base frame 1132 supporting the upper frame 1131.

A rack gear 1131a may be provided on at least a portion of the upper frame 1131. The rack gear 1131a may include a plurality of teeth and a plurality of valleys, as a member for guiding the vertical movement of the massage module 1110.

According to an embodiment of the present invention, the rack gears 1131a may be provided on both sides of the upper frame 1131 to face each other, and the massage module 1110 may move along the rack gears 1131a.

In FIG. 2, the rack gears 1131a are formed in the vertical direction, but are not limited thereto. The rack gears 1131a may include a front-rear direction rack gear and a vertical rack gear. The front-rear direction in the present invention means the direction heading towards the user from the massage module 100 or heading towards the massage module 100 from the user, and may means the X-axis direction based on FIG. 2.

The massage module 1110 may include gears meshing with the rack gears 1131a. More specifically, the massage module 1110 may include gears that respectively mesh with the front-rear direction rack gear and the vertical rack gear. By the rotation of the gear by an actuator equipped on the massage module 1110, the massage module 1110 can move forward, backward, upward, or downward.

As the massage module 1110 moves forward, the intensity of the massage may increase. Additionally, as the massage module 1110 moves backward, the intensity of the massage may decrease.

The rack gear 1131a may be made of metal or plastic materials. For example, the rack gear 1131a may be made of iron, steel, alloy, reinforced plastic, melamine resin, phenolic resin, etc., but is not limited thereto.

The upper frame 1131 may be realized in various shapes. For instance, the upper frame 1131 may be classified into an S-frame, an L-frame, an S&L frame, a double S&L frame according to shapes, but is not limited thereto.

The S-frame refers to a frame where at least a portion of the upper frame 1131 includes a curved shape like “S”. The L-frame means a frame that includes a bent shape like “L” in at least a portion of the upper frame 1131. The S&L frame means a frame including an “S”-shaped curved form and an “L”-shaped bent form. The double S&L frame means a frame including an “L”-shaped bent form and two “S”-shaped curved forms.

The base frame 1132 means a part which supports the upper frame 1131 and contacts the ground or the installation surface of the massage device 1000. The base frame 1132 may include an upper base frame 1132a and a lower base frame 1132b.

The upper base frame 1132a may support the upper frame 1131, and the lower base frame 1132b may come into contact with the ground or the installation surface of the massage device 1000. Additionally, the upper base frame 1132a can be positioned to contact the lower base frame 1132b.

According to an embodiment of the present invention, the upper base frame 1132a can move along the lower base frame 1132b. For instance, the upper base frame 1132a can slide forwards or backwards along the lower base frame 1132b. In this case, the upper frame 1131 is connected to the upper base frame 1132a, can move according to the movement of the upper base frame 1132a.

For example, when the upper base frame 1132a moves forward, the upper frame 1131 can also move forward, and when the upper base frame 1132a moves backward, the upper frame 1131 can also move backward. As a result, the sliding movement of the body massage unit 1100 can be permitted.

To allow the movement of the upper base frame 1132a, a moving wheel may be provided on the underside of the upper base frame 1132a. Additionally, a guide member, which can guide the moving wheel, may be provided on the top of the lower base frame 1132b. The moving wheel provided on the upper base frame 1132a can move along the guide member provided on the lower base frame 1132b, allowing for the forward or backward movement of the upper base frame 1132a.

According to another embodiment of the present invention, the massage device 1000 may not provide a sliding function, and in this case, the base frame 1132 may not be separated into upper and lower frames.

FIG. 3 is a view illustrating a detailed configuration of a massage device according to an embodiment of the present invention.

According to an embodiment of the present invention, the massage device 1000 may include at least one among a control unit 1400, a sensor unit 1410, a communication unit 1420, memory 1430, an audio output unit 1440, and an interface unit 1450. The control unit 1400 may include at least one processor and a memory. The at least one processor can execute instructions stored in memory.

The control unit 1400 can control the massage device 1000. For example, the control unit 1400 can control at least one among the body massage unit 1100, the arm massage unit 1200, the leg massage unit 1300, the sensor unit 1410, the communication unit 1420, the memory 1430, the audio output unit 1440, the interface unit 1450, and the output part. Moreover, the control unit 1400 can control various detailed configurations necessary for the operation of the massage device 1000, which are not described above.

The control unit 1400 may include one processor, or a plurality of processors. When the control unit 1400 includes the plurality of processors, at least some of the plurality of processors can be located at physically distanced locations. In addition, the massage device 1000 is not limited thereto, and can be realized in various ways.

According to an embodiment of the present invention, the control unit 1400 may control the operation of the massage device 1000. For instance, the massage device 1000 may include a plurality of actuators, and the control unit 1400 can control the operation of the massage device 1000 by controlling the operation of the plurality of actuators.

For example, the massage device 1000 may include at least one among a driving unit that moves the armrest frame support, at least one actuator included in the massage module 100, a back angle actuator, a leg angle actuator, a foot massage actuator, a leg length adjustment actuator, and a sliding actuator.

The back angle actuator is an actuator which adjusts the angle of a part of the massage device 1000 contacting with the user's back, and the back angle of the massage device 1000 can be adjusted by the operation of the back angle actuator. The leg angle actuator is an actuator to adjust the angle of the leg massage unit 1300 of the massage device 1000, and the angle between the leg massage unit 1300 and the body massage unit 1100 can be adjusted by the operation of the leg angle actuator. The foot massage actuator represents an actuator that operates the foot massage module included in the leg massage unit 1300. For instance, the control unit 1400 can provide a foot massage to the user using the foot massage actuator. The leg length adjustment actuator represents an actuator that adjusts the length of the leg massage unit 1300. For example, the control unit 1400 can adjust the length of the leg massage unit 1300 to fit the user using the leg length adjustment actuator, and as a result, the user can receive a massage suited to the body shape.

At least one actuator included in the massage module 1110 may be an actuator of various kinds such as a moving actuator, a forward-backward actuator, and a massage actuator.

The moving actuator is an actuator that enables the up and down movement of the massage module 1110, which can move the massage module 1110 in at least one of the upward direction and the downward direction of the massage device 1000 along the main frame 1130. The massage module 1110 can move along the rack gear due to the operation of the moving actuator. The forward-backward actuator can advance (or tilt) the massage module 1110 in at least one of the forward and backward directions. The massage module 1110 can tilt in at least one of the forward and backward directions through the forward-backward actuator. The massage actuator can move the massage module 1110 in various ways to provide various massage actions to the user.

The control unit 1400 can control the operation of the massage device 1000 by controlling the detailed configuration of the massage device 1000.

The control unit 1400 can provide various massage actions by operating at least one actuator included in the massage device 1000. For example, the control unit 1400 can provide a tapping massage, a kneading massage, and so on by operating at least one actuator included in the massage module 1110, but is not limited thereto, and can provide various massage actions.

The memory 1430 may be included in the control unit 1400 or can be located outside the control unit 1400. The memory 1430 can store various pieces of information related to the massage device 1000. For instance, the memory 1430 may include massage control information, user information, and is not limited thereto. User information may contain various kinds of information associated with the user, such as personal authentication information, the user's biometric information (for example, age, height, weight, blood pressure, body composition, pulse, electrocardiogram, etc.) and the like.

The memory 1430 can be realized through a non-volatile storage medium, which can continuously store arbitrary data. For example, the memory 1430 may include storage devices based on a disk, an optical disk, a magneto-optical storage device, a flash memory and/or a battery-backup memory, and is not limited thereto.

The memory 1430 is a first storage device directly accessed by the processor, such as a random access memory (RAM) like a dynamic random access memory (DRAM) and a static random access memory (SRAM), and means a volatile storage device in which stored information is instantly erased when power is turned off, but it is not limited thereto. The memory 1430 can be operated by the control unit 1400.

The massage device 1000 may include a sensor unit 1410. The sensor unit 1410 can acquire various information using at least one sensor. The sensor unit 1410 can be equipped with sensors using measurement means such as pressure, potential, and optics. For example, the sensor unit may include a pressure sensor, an infrared sensor, an LED sensor, a touch sensor, an electrode sensor, an air pressure measurement sensor, but is not limited thereto.

The sensor unit 1410 may include a biometric information acquisition sensor. The biometric information acquisition sensor can acquire at least one of fingerprint information, face information, voice information, iris information, weight information, blood pressure information, heartbeat (or heart rate) information, electrocardiogram information, body composition information, and is not limited thereto, and may include various biometric information. The massage device 1000 can provide a customized massage based on the information acquired through the sensors.

The massage device 1000 can detect a contact area and/or a contact position with the user through the sensors. Moreover, the massage device 1000 can provide a customized massage based on the information acquired through the sensors. The sensor unit 1410 may include a safety sensor module 1500. The safety sensor module 1500 can control the operation of the leg massage unit 1300 or issue a warning to the user when pressed by the user's body or by other objects. A detailed description of the safety sensor module 1500 will be described later.

The communication unit 1420 can receive a signal transmitted from an external device or transmit a signal about the massage device 1000 to the external device.

For example, the control unit 1400 can process the signal received through the communication unit 1420 to acquire a result signal, and can transmit the result signal to the communication unit 1420. The communication unit 1420 can transmit (or output) the result signal to the external device.

The control unit 1400 can acquire information on various components included in the massage device 1000 (for instance, information on the massage module 1110, information on the arm massage unit 1200, etc.), and can transmit the information to the communication unit 1420. The communication unit 1420 can transmit the information regarding the massage device 1000 to the external device.

The communication unit 1420 can communicate with an internal module of the massage device 1000, an external massage device and/or a user terminal via any type of network. The communication unit may include a wired/wireless connection module for network access. For wireless connection technology, for example, there are WLAN (Wireless LAN) (Wi-Fi), Wibro (Wireless broadband), Wimax (World Interoperability for Microwave Access), HSDPA (High-Speed Downlink Packet Access), and the like. For wired connection technology, for instance, there are XDSL (Digital Subscriber Line), FTTH (Fibers to the home), PLC (Power Line Communication), and the like. In addition, the network connection unit may include a short-range communication module, which allows data transmission and reception with any device/terminal located in close range. For short-range communication technology, there are

Bluetooth, RFID (Radio Frequency Identification), IrDA (infrared Data Association), UWB (Ultra-Wideband), ZigBee, and the like, and the communication technologies are not limited thereto.

The massage device 1000 may further include an interface unit 1450.

The interface unit 1450 may be arranged on at least a portion of the massage device 1000. For example, the interface unit 1450 may be arranged on the exterior of the arm massage unit 1200.

The interface unit 1450 may include an input unit and/or an output unit. The input unit can receive user input from the user and transmit it to the control unit 1400. The output unit can display information about the massage device 1000. For example, the output unit can display various information such as the processing results of the control unit 1400, operation information of at least one of the body massage unit 1100, the arm massage unit 1200, and the leg massage unit 1300, information on the massage mode being performed.

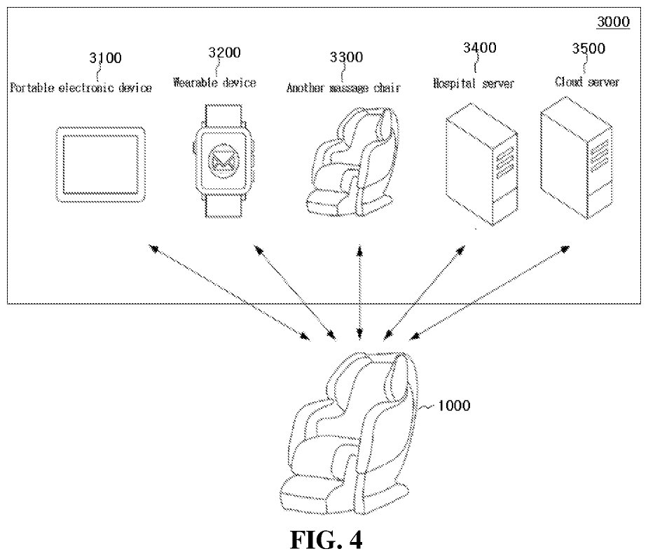

Specifically, the input unit can receive commands related to the operation control of the massage device 1000 from the user, and the input unit may be realized in various forms. For example, the input unit can be equipped in the body massage unit 1100, and can be equipped in the leg massage unit 1300, but is not limited thereto. In addition, the input unit may include a user input unit 1140 of FIG. 1, a massage device control device 2000, or various external devices to be described in FIG. 4.

The massage device 1000 can acquire various commands from the user through the input unit. For example, the massage device 1000 can receive any command for selection of the massage module, selection of massage type, selection of massage intensity, selection of massage time, selection of the massage area, selection related to the position and operation of the body massage unit 1100, on-off selection for the power of the massage device 1000, selection regarding the operation of the heat function, selection related to music playback, and more, but is not limited thereto.

The massage device 1000 can provide an interface for selecting the massage mode through the interface unit 1450. For example, the input unit and/or output unit may include a massage device control device 2000. Medical massages of various modes related to body improvement can be listed through the massage device control device 2000.

The medical massage mode may include at least one among a focus mode, a meditation mode, a recovery mode, a stretching mode, a sleep mode, a vitality mode, a golf mode, a hip up mode, a student mode, a zero gravity mode, and a growth mode.

According to another embodiment of the present invention, the interface unit 1450 may include buttons in the form of a hot key and/or selection buttons to execute direction selection, cancellation, and input, depending on pre-set user settings or its own pre-set functions.

The interface unit 1450 can be realized as a touchscreen, a keypad, a dome switch, a touch pad (pressure/static), a jog wheel, a jog switch, and others, but is not limited thereto. Moreover, the interface unit 1450 can acquire commands through the user's speech based on voice recognition technology.

The output unit may include a display for displaying the operating situation of the massage device 1000 or the current status of the user. In this case, the display may include at least one of a liquid crystal display (LCD), a thin film transistor-liquid crystal display (TFT LCD), an organic light emitting diode (OLED), a flexible display, a 3D display, and the like, but is not limited thereto.

The output unit may include an audio output unit 1440. The audio output unit 1440 of FIG. 3 may include the audio output module 1120 of FIG. 1. For instance, the audio output module 1120 may be arranged at various locations of the massage device 1000. The audio output module 1120 can be placed in the area corresponding to the user's head among the entire areas of the body massage unit 1100 of the massage device 1000 as illustrated in FIG. 1. In this case, the area corresponding to the user's head may be an area corresponding to at least one side of the upper two sides of the entire area of the body massage unit 1100.

The audio output unit 1440 can provide any type of audio output to the user. For example, the audio output unit 1440 can provide brain stimulation to the user by outputting music and/or binaural beats optimized for the massage pattern provided by the massage device 1000. The audio output unit 1440 can output an acoustic signal received through a network (not illustrated) or stored in an internal/external storage medium (not illustrated). For instance, the audio output unit 1440 can output music controlled by the user's terminal through a network connection (e.g., a Bluetooth connection) with the user's terminal. In addition, the audio output unit 1440 can output any type of acoustic signal related to the operation of the massage device 1000.

Those skilled in the art to which the present invention belongs would know well that the present invention can be realized by being combined with other program modules and/or by a combination of hardware and software. For example, the present invention can be realized by a computer-readable medium.

A medium accessible by a computer can be any computer-readable medium, and such a computer-readable medium includes volatile and non-volatile media, transitory and non-transitory media, and removable and non-removable media. As an example, without limitation, a computer-readable medium may include a computer-readable storage medium and a computer-readable transmission medium.

The computer-readable storage medium includes volatile and non-volatile, transitory and non-transitory, removable and non-removable media realized by any method or technology for storing information such as computer-readable instructions, data structures, program modules, or other data. The computer-readable storage medium includes RAMs, ROMs, EEPROMs, flash memories or other memory technology, CD-ROMs, digital video disks (DVD) or other optical disk storage devices, magnetic cassettes, magnetic tape, magnetic disk storage devices or other magnetic storage devices, or any other medium that can be accessed by a computer and used to store desired information, but is not limited thereto.

Hereinafter, referring to the drawings, the massage device 1000 having the rotatable arm massage unit according to an embodiment of the present invention will be described in detail.

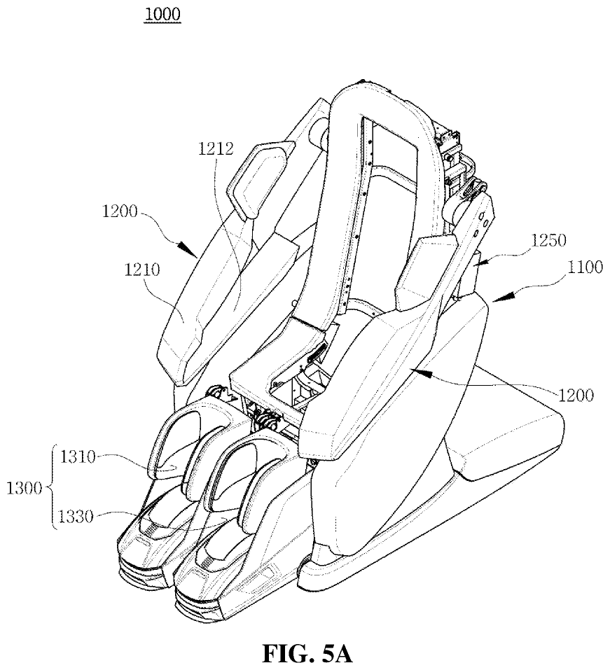

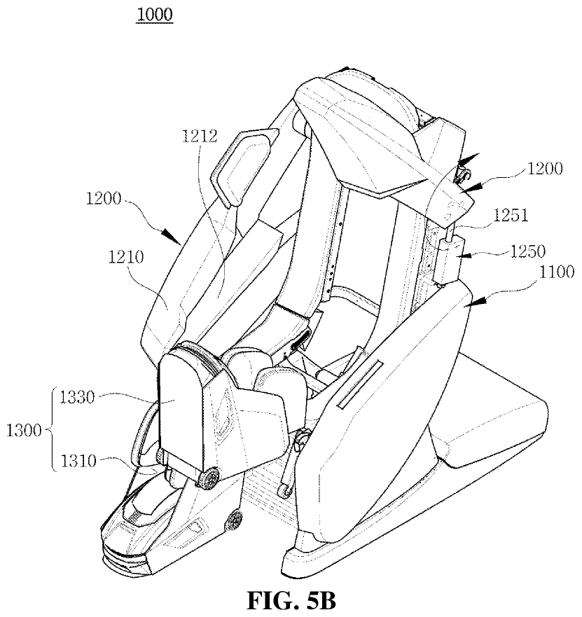

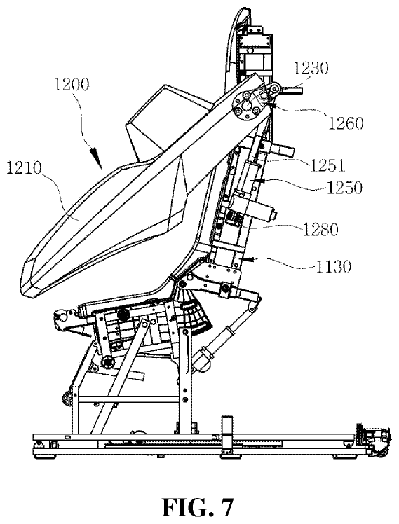

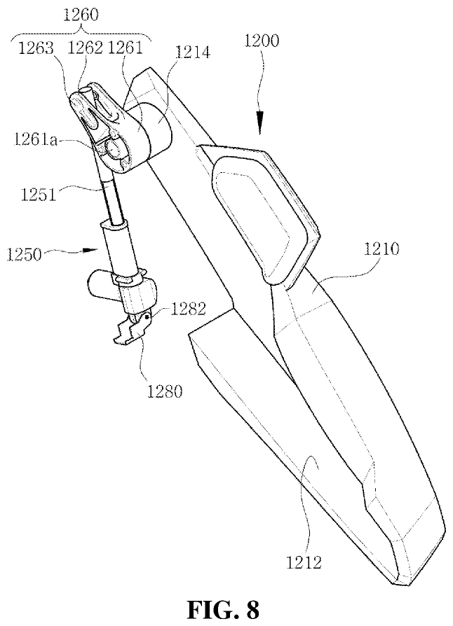

FIGS. 5A through 10 illustrate a massage device 1000 comprising a rotatable arm massage unit according to an embodiment of the present invention.

The massage device 1000 can be configured such that at least one arm massage unit 1200 can be rotated in at least one direction relative to the body massage unit 1100. For example, the arm massage unit 1200 may include first and second arm massage units 1201 and 1202 (see FIG. 1) located on both sides of the body massage unit 1100. The first and second arm massage units 1201 and 1202 can be configured to rotate independently upwards and/or laterally with respect to the body massage unit 1100.

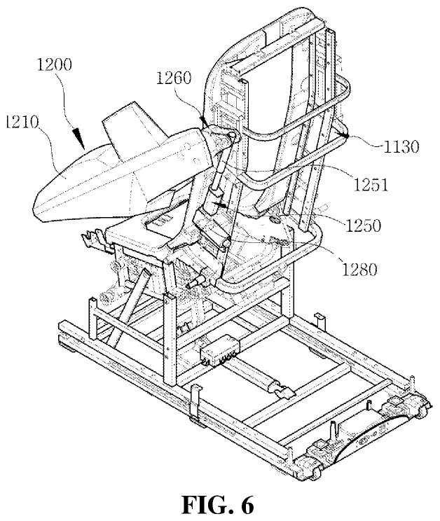

Referring to FIGS. 5A, 6B, and 6, the massage device 1000 according to an embodiment of the present invention may include a main frame 1130 forming the skeleton of the massage device 1000, a body massage unit 1100 massaging the user's body, and arm massage units 1200 respectively positioned on both sides of the body massage unit 1100 to each accommodate and massage the user's arms.

As described above, the body massage unit 1100 may be a means to provide a massage to at least a portion of the user's body.

For example, the body massage unit 1100 may have a space formed to accommodate at least a portion of the user's body.

In an embodiment, the accommodation space of the body massage unit 1100 may be a space for the user to sit. That is, the user can sit in the space formed in the body massage unit 1100, and the user can receive a massage while sitting.

The main frame 1130 may be arranged inside the body massage unit 1100 and can serve as a means to form the skeleton of the body massage unit 1100.

In a selective embodiment, the body massage unit 1100 may include a cover which covers a massage module 1110, which is placed inside, not to be exposed to the outside.

The arm massage unit 1200 may be a means to provide a massage or stretching to the user's arm. For instance, the arm massage unit 1200 may include various components for massaging the user's arm, such as a massage module for providing a massage to the user's arm, air cells, and the like.

On the other hand, as described later, the arm massage unit 1200 can provide at least one of stretching, other medical treatments, and a massage by rotating in at least one direction.

Hereinafter, as will be described below, providing a massage to the user's arm should be understood not only as providing a massage (e.g., pressing massage (or acupressure), tapping massage, kneading massage, etc.), but also as including at least one of various actions of the arm massage unit 1200 provided to the user's arm, that is, stretching performed by rotating or expanding the user's arm in a specific direction, and other medical treatments.

Furthermore, the arm massage unit 1200 can also provide a function that minimizes interference between the arm massage unit 1200 and the user's body by rotating at least in one direction when the user sits in the body massage unit 1100 or stands up after using, thereby facilitating the user's seating or standing up from the body massage unit 1100. For instance, just before the user sits in the body massage unit 1100 or just before the user stands up from the body massage unit 1100, a rotation module can rotate both or one side of the arm massage unit 1200 upwards to open at least one side of the body massage unit 1100, making the seating or standing-up motion more convenient.

The arm massage unit 1200 may be arranged on both sides of the body massage unit 1100. For example, the arm massage units 1200 may be respectively arranged in positions (or areas) corresponding to the user's arms over the entire bilateral area of the body massage unit 1100. Each arm massage unit 1200 may have a space to accommodate the user's arm.

The arm massage unit 1200 may include armrest frames 1210 respectively connected to both sides of the main frame 1130. The armrest frames 1210 can rotate around rotational shafts 1230 respectively installed on both sides of the main frame 1130. The rotational shaft 1230 can be placed near one end (or the upper end) of the upper frame 1131. In this case, both top ends of the upper frame 1131 correspond to the user's shoulders, and may correspond to the upper rear of the user's shoulders. The rotational shaft 1230 can be directly connected to the upper portion of the upper frame 1131 near the user's bilateral shoulder rear or can be connected to the upper frame via a bracket, or a plate or a frame structure, and can rotate around an axis extending laterally from the top of the upper frame 1131.

A ‘C’-shaped armrest recess 1212 which is opened to the side interior and the rear may be provided on the front side of the arm massage frame 1210 so that the user's arm can be inserted. Inside the armrest recess 1212, at least one of an air cell, a massage module, and a heating module for massaging the user's arm may be included. The air cell can massage the user's arm area by expanding and contracting through air supply and discharge, the massage module is configured to vibrate the arm area by an actuator, and the heating module is configured to provide a massage effect by applying heat to the arm area.

The armrest frame 1210 can rotate vertically around the rotational shaft 1230 by the rotation module. The rotation module can be configured to convert a linear motion of the actuator into a rotational motion of the arm massage unit 1200 to rotate the arm massage unit 1200. For instance, the rotation module can be configured to rotate the arm massage unit 1200 around the rotational shaft 1230 at a predetermined angle in the vertical direction of the massage device 1000. The rotation module for rotating the arm massage unit 1200 in the vertical direction includes: an arm rotation actuator 1250 which has an end connected to the main frame 1130 of the body massage unit 1100 and includes an expandable rod 1251 expanding or contracting in one direction; and a motion conversion member 1260 which is connected to the other end of the arm rotation actuator 1250 and converts the linear motion of the expandable rod 1251 into the rotational motion of the arm massage unit 1200.

The arm rotation actuator 1250 may be at least one among a pneumatic actuator, an electric actuator, a hydraulic actuator, and an electro-hydraulic actuator to enable the expandable rod 1251 to expand and contract. For example, the expandable rod 1251 of the arm rotation actuator 1250 can be expanded or contracted while performing a linear reciprocating motion by rotational force of a motor operating by electric power supplied by a control unit 1400 (see FIG. 3). Alternatively, the expandable rod 1251 of the arm rotation actuator 1250 can be expanded or contracted while performing a linear reciprocating motion by pneumatic pressure and/or hydraulic pressure supplied by the control unit 1400.

The arm rotation actuator 1250 has an end connected to one side of the main frame 1130, and the other end connected to the motion conversion member 1260. For instance, since the end of the expandable rod 1251 is connected to the motion conversion member 126, the arm rotation actuator 1250 can transfer rotational force to the arm massage unit 120 through the motion conversion member 1260 as the expandable rod 1251 moves linearly.

The motion conversion member 1260, which converts the linear motion of the expandable rod 1251 into the vertical rotational motion of the arm massage unit 1200, can be configured to transfer the rotational force of the arm massage unit 1200 while rotating around the rotational shaft 1230 coupled to the main frame 1130.

For example, the motion conversion member 1260 may include: a crank head 1261 of which the central portion is rotatably connected around the rotational shaft 1230 coupled to the main frame 1130 and one side is connected to the arm massage unit 1200; a crank blade 1262 which is formed on the crank head 1261 to extend in the radial direction of the crank head 1261 and has an elongated guide hole 1264; and a crank connection member 1263 which connects the expandable rod 1251 of the arm rotation actuator 1250 to the guide hole 1264 and moves along the guide hole 1264.

The crank head 1261 can be approximately cylindrical in shape, and may have a shaft hole 1261a which is perforated bidirectionally in the center where the rotational shaft 1230 is inserted and connected. One end of the rotational shaft 1230 can be connected to one side of the upper frame 1131, and the crank head 1261 can rotate with respect to the rotational shaft 1230. One side of the crank head 1261 can be connected to the arm massage unit 1200. For instance, one side of the crank head 1261 can be firmly connected to a cylindrical rotation coupling part 1214 protruding inwardly from the rear side of the arm massage unit 1200 by means of fasteners such as bolts or screws.

To ensure that the crank head 1261 and arm massage unit 1200 are connected at a predetermined exact position when one side of the crank head 1261 is connected to the rotation coupling part 1214 of the arm massage unit 1200, a misassembly prevention part guiding the connecting position between the crank head 1261 and the arm massage unit 1200 may be provided on one side of the crank head 1261 and on one side of the arm massage unit 1200. For example, the misassembly prevention part may include: a plurality of assembly grooves (not illustrated) formed concavely on one side of the rotation coupling part 1214 of the arm massage unit 1200; and a plurality of assembly protrusions 1265 protruding from one side of the crank head 1261, and individually inserted into the assembly grooves formed on the rotation coupling part 1214.

The crank blade 1262 can be integrally formed on one side of the crank head 1261. The crank blade 1262 may have a plate shape extending radially from one side of the crank head 1261, and a single crank blade may be formed on the crank head 1261.

As described above, the crank blade 1262 may be formed as a single piece, but is not limited thereto. For instance, the crank blades 1262 may be provided in plural, and extend in the radial direction at both sides of the crank head 1261. The plurality (hereinafter, assuming as two crank blades) of crank blades 1262 may spaced apart from each other at a predetermined distance, and may be formed parallel to each other. In this instance, the end of the expandable rod 1251 of the arm rotation actuator 1250 can be inserted into a space between the two crank blades 1262 and can be connected to move relative to the crank blade 1262 through the crank connection member 1263.

A guide hole 1264 for connecting with the arm rotation actuator 1250 may be formed on the crank blade 1262 in an elongated hole shape extending in the radial direction of the crank head 1261.

The crank connection member 1263 may be a bushing inserted into the inner side of the guide hole 1264 of the crank blade 1262. The central portion of the bushing can be connected to the end of the expandable rod 1251 of the arm rotation actuator 1250 by a fastener. The fastener can be configured using at least one of various fastening means such as bolts, screws, and pins.

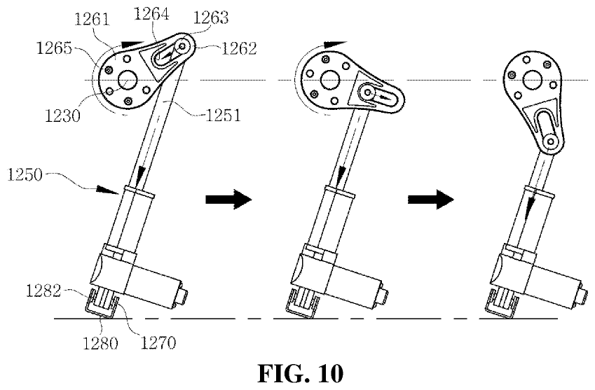

As illustrated in FIG. 10, as the expandable rod 1251 of the arm rotation actuator 125 contracts and/or extends, the crank connection member 1263 connected to the expandable rod 1251 of the rotation actuator 1250 can apply power to pull or push the crank blade 1262 while sliding along the guide hole 1264 of the crank blade 1262. Therefore, the crank head 1261 rotates around the rotational shaft 1230, and the arm massage unit 1200 performs a rotational motion around the rotational shaft 1230.

According to the rotation module having the configuration described above, since the linear motion of the expandable rod 1251 of the arm rotation actuator 1250 in a fixed state is converted into the rotational motion through the motion conversion member 1260 and is transmitted to the arm massage unit 1200, the arm massage unit 1200 can be rotated very smoothly, and minimize noise and vibration during the rotation. In other words, the rotation of the arm massage unit 120 by the arm rotation actuator 1240 and the rotation module results in much less vibration and noise than the rotation of the arm massage unit 1200 only by the arm rotation actuator 1250, since the arm rotation actuator 1250 does not vibrate laterally while the expandable rod 1251 of the arm rotation actuator 1250 expand and/or contract. So, the present invention can reduce an installation space of the arm rotation actuator 1250, and remove an interference between the arm rotation actuator 1250 and other components.

One end of the arm rotation actuator 1250 can be connected to the main frame 1130. For instance, the bottom portion of the arm rotation actuator 1250 can be connected to the actuator bracket 1280 fixed to the main frame 1130 by fastening means such as a connection pin 1282 to be relatively rotatable. At this time, the connection pin 1282 and the rotational shaft 1230 may be installed to be spaced at a predetermined angle. For instance, the connection pin 1282 and the rotational shaft 1230 may be installed orthogonally to each other. Specifically, the connection pin 1282 may be installed in the back-and-forth direction (Y-axis direction) of the massage device 1000, and the rotational shaft 1230 may be installed in the left-and-right direction (X-axis direction) of the massage device 1000. When the arm massage unit 1200 rotates vertically around the rotational shaft 1230, the connection pin 1282 installed at the bottom of the arm rotation actuator 1250 can resist without rotation with respect to the main frame 113.

When the arm massage unit 1200 rotates by the expansion and contraction of the expandable rod 1251 of the arm rotation actuator 1250, a moment can be generated in the rotation direction of the motion conversion member 1260. Such a moment can apply force on the connecting pin 1282, which is a connection portion between the arm rotation actuator 1250 and the main frame 113, causing noise and vibration by a breakage, a damage, or an abrasion of the connection pin 1282.

As described above, in order to attenuate the noise and the vibration caused by the moment generated when the expandable rod 1251 of the arm rotation actuator 1250 is expanded or contracted and the arm massage unit 1200 rotates, the massage device 1000 may include damper members 1270. For instance, one end, e.g., the bottom, of the arm rotation actuator 1250 can be inserted between the two sides of the ‘U’-shaped actuator bracket 1280 coupled to the main frame 1130, and can be connected to the actuator bracket 1280 by the connection pin 1282 crossing both sides of the actuator bracket 1280. At this time, the actuator bracket 1280 can be firmly coupled to the main frame 1130.

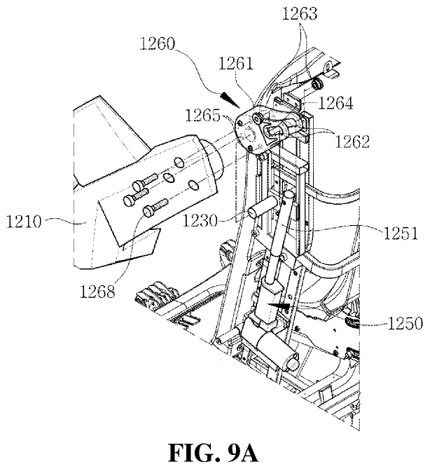

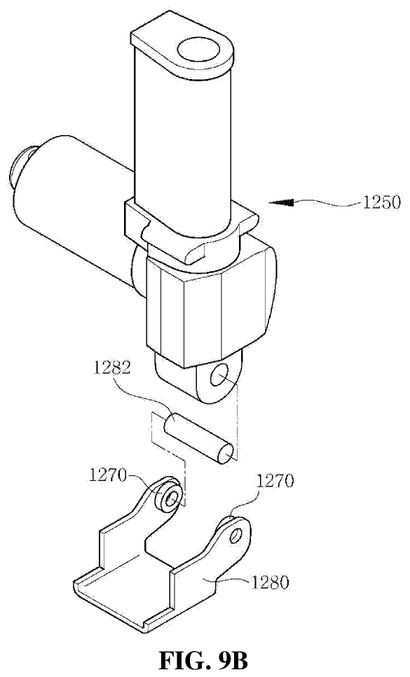

The damper members 1270, as illustrated in FIG. 9b, can be respectively arranged between both sides of the bottom of the arm rotation actuator 1250 and both sides of the actuator bracket 1280 to function to attenuate the moment applied to the connecting pin 1282. The damper member 1270 can be made of an elastic material like rubber that absorbs external forces.

As described above, the massage device 1000 can operate the arm rotation actuator 1250 of the rotation module to rotate the arm massage unit 1200 up and down or left and right within the massage device 1000 to provide various massage and stretching functions to the user.

In addition, the massage device 1000 can operate the rotation module just before and/or just after a user sits or stands up from the body massage unit 1100 to rotate the arm massage unit 1200, so that at least one side of the body massage unit 1100 is opened., thereby enabling the user to sit in the body massage unit 1100 conveniently, and to comfortably sit or stand up from the body massage unit 1100.

Meanwhile, as illustrated in FIGS. 5A, 5B, and 11 through 12, the massage device 1000 according to an embodiment of the present invention can further include leg massage units 1300 which can rotate individually.

The leg massage units 1300 can be provided to correspond to both legs of the user. For instance, the leg massage units 1300 may include a first leg massage unit 1310, which corresponds to one leg of the user, and a second leg massage unit 1330, which corresponds to the other leg of the user.

The first leg massage unit 1310 and the second leg massage unit 1330 can be controlled independently. For example, the first leg massage unit 1310 and the second leg massage unit 1330 can individually provide a massage function to the user. Additionally, the first leg massage unit 1310 and the second leg massage unit 1330 can rotate independently. As occasion demands, the user may receive different massages on each leg or receive a massage on both legs alternatingly. Additionally, the user may receive stretching or massages on both legs due to rotation. In this case, the first leg massage unit 1310 and the second leg massage unit 1330 may rotate both legs of the user simultaneously or individually.

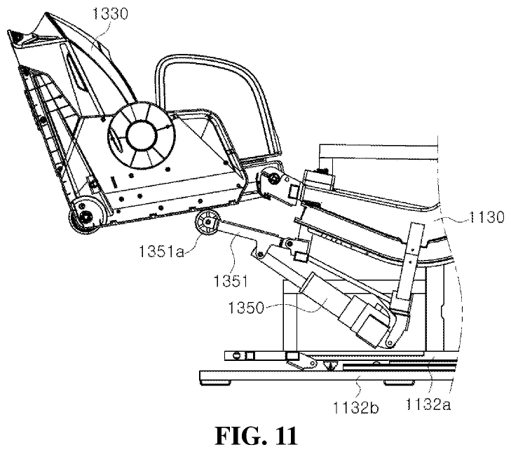

Referring to FIG. 11, the massage device 1000 may include a leg angle actuator 1350 for rotating the leg massage unit 1300. The leg angle actuator 1350 may be arranged inside the body massage unit 1100. For example, the leg angle actuator can be connected to the main frame 1130.

The leg angle actuator 1350 can be driven to extend in one direction. As the leg angle actuator 1350 extends, the leg massage unit 1300 can rotate. The leg angle actuator 1350 can be provided to correspond individually to the first leg massage unit 1310 and the second leg massage unit 1330. Two leg angle actuators 1350 can be connected to the first leg massage unit 1310 and the second leg massage unit 1330, respectively, to rotate the first leg massage unit 1310 and the second leg massage unit 1330 independently.

The leg angle actuator 1350 may include a link member 1351 at an end. The link member 1351 gets in contact with the leg massage unit 1300 to provide rotational force to the leg massage unit 1300. The link member 1351 may have a wheel 1351a provided at an end portion facing the leg massage unit 1300.

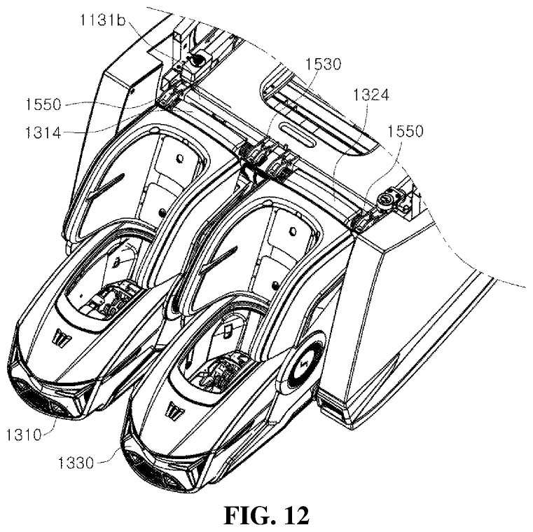

Referring to FIG. 12, the leg massage unit 1300 can be rotatably connected to the leg connection frame 1131b arranged on the main frame 1130. The upper frame 1131 may include the leg connection frame 1131b. The leg connection frame 1131b can be provided at the front end of the upper frame 1131. The leg connection frame 1131b can be manufactured as a separate component and coupled to the upper frame 1131 or can be manufactured integrally with the upper frame 1131. In the case in which the leg connection frame 1131b is manufactured integrally with the upper frame 1131, it means that the leg connection frame 1131b is a component of the upper frame 1131.

A center support bracket 1530 and a side support bracket 1550 may be connected to the central portion and both end portions of the leg connection frame 1131b. For instance, the center support bracket 1530 and the side support brackets 1550 may be welded to the leg connection frame 1131b or may be coupled by fastening members such as bolts or rivets. However, the method of coupling the center support bracket 1530 and the side support brackets 1550 to the leg connection frame 1131b may be replaced with various methods commonly used in the technical field to which the present invention belongs.

The center support bracket 1530 and the side support brackets 1550 can fix the leg massage unit 1300 to be rotatable.

The first leg massage unit 1310 and the second leg massage unit 1330 may be located at the front of the leg connection frame 1131b. For example, the first leg massage unit 1310 may be arranged on the right side at the front of the leg connection frame 1131b, and the second leg massage unit 1330 may be arranged on the left side at the front of the leg connection frame 1131b.

Although the present invention has been described with reference to exemplary embodiments along with the accompanying drawings, it should be understood that this is merely exemplary and not intended to limit the present invention. Furthermore, it is evident to those skilled in the art that various modifications and variations can be made within the scope of the technical concept of the present invention without departing from the scope thereof.

Additionally, the configuration and functions of the massage device in this specification can be expanded and applied to various (wearable) healthcare devices capable of providing healthcare functions (e.g., massage functions, biometric signal measurement functions, etc.). Therefore, the term ‘massage device’ in this specification can be replaced with ‘(wearable) healthcare device’ as well.

### SEQUENCE LIST

1000: Massage device 1100: Body massage unit
1200: Arm massage unit 1210: Armrest frame
1230: Rotational shaft 1250: Arm rotation actuator
1251: Expandable rod 1260: Motion conversion member
1261: Crank head 1262: Crank blade
1263: Crank connection member 1264: Guide hole
1265: Assembly protrusion 1270: Damper member
1280: Actuator bracket 1300: Leg massage unit

1. A massage device comprising:
a body massage unit including a main frame forming the skeleton of the massage device, and massaging a user's body;
arm massage units respectively arranged on both sides of the body massage unit, accommodating both arms of the user, and configured on the body massage unit to rotate around a rotational shaft; and
a rotation module rotating the arm massage units,
wherein the rotation module comprises: an arm rotation actuator which has an end connected to the main frame and includes an expandable rod expanding or contracting in one direction; and a motion conversion member which is connected to the other end of the arm rotation actuator and the arm massage unit, and converts a linear motion of the expandable rod into a rotational motion of the arm massage unit.

2. The massage device according to claim 1, wherein the motion conversion member is connected to the rotational shaft, and rotates around the rotational shaft.

3. The massage device according to claim 1, wherein the motion conversion member comprises: a crank head which is connected to the main frame to rotate around the rotational shaft and of which one side is connected to the arm massage unit; a crank blade which is formed on the crank head to extend in the radial direction and has an elongated guide hole; and a crank connection member which connects the arm rotation actuator to the guide hole and moves along the guide hole.

4. The massage device according to claim 3, wherein an assembly groove guiding a coupling position of the crank head and the arm massage unit and an assembly protrusion inserted into the assembly groove are respectively formed on one side of the crank head and on one side of the arm massage unit.

5. The massage device according to claim 3, wherein the crank connection member comprises:
a bushing inserted into the guide hole to slide along the guide hole; and
a fastener penetrating the central portion of the bushing and connecting the bushing to the crank connection member.

6. The massage device according to claim 1, wherein a damper member of an elastic material is installed at an end of the arm rotation actuator connected to the main frame to attenuate noise and vibration caused by a moment generated while the expandable rod of the arm rotation actuator is expanded or contracted.

7. The massage device according to claim 6, wherein a ‘U’-shaped actuator bracket is coupled to the main frame, one end of the arm rotation actuator is inserted between both sides of the actuator bracket, the damper member is arranged between both sides of the actuator bracket and one end of the arm rotation actuator, and the central portion of the damper member is connected to one end of the arm rotation actuator by a connecting pin.

8. The massage device according to claim 1, wherein the rotation module is controlled such that the arm massage unit rotates upward just before a user sits on or stands up from the body massage unit.

9. The massage device according to claim 1, further comprising:
a leg connection frame installed in the body massage unit;
a first leg massage unit rotatably connected to the leg connection frame and accommodating one leg of a user;
a second leg massage unit, spaced from one side of the first leg massage unit, connected to the leg connection frame to be rotated individually relative to the first leg massage unit, and accommodating the other leg of the user;
a connection module connecting the first leg massage unit and the second leg massage unit respectively to the leg connection frames; and
a leg rotation module providing rotational force to individually rotate the first leg massage unit and the second leg massage unit.

10. The massage device according to claim 9, wherein the connection module comprises:
a center support bracket provided on the leg connection frame, and supporting the inner sides of both the first leg massage unit and the second leg massage unit to be rotatable; and
a side support bracket provided on the leg connection frame, and supporting the outer sides of both the first leg massage unit and the second leg massage unit to be rotatable.
